(19) United States
(12) Patent Application Publication
(10) Pub. No.: US 2016/0249672 A1
(43) Pub. Date: Sep. 1, 2016

(54) COATED FOOD PRODUCT AND METHOD OF PREPARATION

(71) Applicant: GENERAL MILLS, INC., Minneapolis, MN (US)

(72) Inventors: Kathryn E. Burton, Minneapolis, MN (US); Daniel R. Green, Minnetonka, MN (US)

(73) Assignee: GENERAL MILLS, INC., Minneapolis, MN (US)

(21) Appl. No.: 14/633,396

(22) Filed: Feb. 27, 2015

(51) Int. Cl. A23P 1/08

(52) U.S. Cl. CPC A23P 1/085

(57) ABSTRACT

Disclosed are methods and systems for coating food pieces with edible particles. The methods include simultaneously applying liquid and edible particle components of a coating to a food piece.

### FIELD OF INVENTION

The present invention relates to coated food products and to their methods of preparation. More particularly, the present invention relates to methods for preparing coated food products with edible particles.

### BACKGROUND OF THE INVENTION

A wide variety of food products comprise a base food piece having a topical coating to improve the taste, appearance, nutrition, texture, stability, or to provide improved shelf-life or other feature of the product. Methods that topically apply edible particles to base food pieces are typically limited to applying fine particles having an average diameter of less than 300 μm. If larger particles are desired, the particles are typically separately applied to a food piece after applying an adhesive coating that acts to adhere the particles to the food piece. There exists, therefore, a need for a coating method that simultaneously applies adhesive and edible particle ingredients to a food.

### BRIEF SUMMARY OF THE INVENTION

Provided herein are methods and compositions relating to coating food pieces.

A method for applying edible particles to a food product is provided. In one embodiment, the method includes providing a suspension including a liquid and the edible particles in an amount of from about 10% to about 60% by volume of the suspension, where the edible particles have a sieve distribution of ASTM −4/+80 with at least 20% of the particles being ASTM 50 or larger, combining the suspension with air in a nozzle assembly to produce an air atomized suspension, and directing the air atomized suspension onto the food product to apply the edible particles to the food product.

In some embodiments, the edible particles can have a sieve distribution of ASTM −4/+50, ASTM −4/+18, or ASTM −4/+10.

In some embodiments, the air can be delivered to the nozzle assembly at a pressure of from about 10 pounds per square inch to about 80 pounds per square inch.

The nozzle assembly can have a maximum free passage of from about 0.100 to about 0.400 inches.

In some embodiments, the edible particles can be about 10% to about 40% or about 20% to about 25% by volume of the suspension.

In some embodiments, the edible particles can be about 5% to about 25% of the suspension by weight.

In some embodiments, the air atomized suspension can be expelled from the nozzle assembly in a cone-shaped or fan-shaped spray.

In some embodiments, the edible particles can include nut pieces, cracker crumbs, cookie crumbs, or ready-to-eat cereal crumbs.

In some embodiments, the liquid can include a nut ingredient, a fat ingredient, a carbohydrate ingredient, or a protein ingredient.

In some embodiments, the liquid can have a viscosity at 40° C. of from about 0.001 Pa·s to about 50 Pa·s.

In another embodiment, a method for applying edible particles to a food product includes providing a suspension including a liquid and the edible particles in an amount of from about 10% to about 60% by volume of the suspension, where the edible particles have a size of from about 0.18 mm to about 4.75 mm with at least 20% of the particles being 0.30 mm or larger,

combining the suspension with air in a nozzle assembly to produce an air atomized suspension, and directing the air atomized suspension onto the food product to apply the edible particles to the food product.

In some embodiments, the air can be delivered to the nozzle assembly at a pressure of from about 10 pounds per square inch to about 80 pounds per square inch.

The nozzle assembly can have a maximum free passage of from about 0.100 to about 0.400 inches.

In some embodiments, the edible particles can be about 10% to about 40% or about 20% to about 25% by volume of the suspension.

In some embodiments, the edible particles can be about 5% to about 25% of the suspension by weight.

In some embodiments, the air atomized suspension can be expelled from the nozzle assembly in a cone-shaped or fan-shaped spray.

In some embodiments, the edible particles can include nut pieces, cracker crumbs, cookie crumbs, or ready-to-eat cereal crumbs.

In some embodiments, the liquid can include a nut ingredient, a fat ingredient, a carbohydrate ingredient, or a protein ingredient.

In some embodiments, the liquid can have a viscosity at 40° C. of from about 0.001 Pa·s to about 50 Pa·s.

Additional objects, features and advantages of the present invention will become more readily apparent from the following detailed description of the invention with reference to the drawings.

### BRIEF DESCRIPTION OF THE DRAWINGS

The following drawings are illustrative of particular embodiments of the invention and therefore do not limit the scope of the invention. The drawings are not necessarily to scale (unless so stated) and are intended for use in conjunction with the explanations in the following detailed description. Some embodiments of the invention will hereinafter be described in conjunction with the appended drawings, wherein like numerals denote like elements.

FIG. 1 shows a method of applying edible particles to a food product according to an embodiment.

FIG. 2 shows an example of a nozzle assembly suitable for use in a method of applying edible particles to a food product according to an embodiment.

FIG. 3 shows an example of a top view (top) and side view (bottom) of components for a nozzle assembly suitable for use in a method of applying edible particles to a food product according to an embodiment.

### DETAILED DESCRIPTION

The present disclosure is directed to methods of coating food products and to compositions comprising coated food products. A method provided herein can provide a visually and texturally interesting food product by applying relatively large edible particles to a food product. A method provided herein can have an advantage of applying the edible particles to the food product without requiring separately applying an adhesive coating and the edible particles. By simultaneously applying edible particles and a liquid that serves to adhere the edible particles to a food product, a method provided herein can reduce the number of steps and/or pieces of equipment needed to apply the particles to the food product. In some embodiments, because the liquid and edible particles are applied concurrently, the liquid need not remain tacky to allow for later adhesion of the particles. In some embodiments, a method provided herein can have an advantage of producing a food product coated with edible particles that are resistant to falling off the food product during processing, packaging, and/or storage.

An edible particle, as provided herein, can include, without limitation, crumbs from a food product (e.g., a ready-to-eat cereal crumbs, cookie crumbs, cracker crumbs, or the like), nut pieces (e.g., peanut pieces, walnut pieces, or the like), confectionary pieces (e.g., chocolate pieces, candy pieces, or the like), or the like. Surprisingly, a method provided herein can be used to apply edible particles having a relatively large size to a food product.

Edible particle size can be described herein using an ASTM sieve mesh size distribution. Edible particles useful for use in a method provided herein can include particles with a sieve mesh size distribution ranging from ASTM 80 to ASTM 4, or any smaller range within the range of ASTM 80 and ASTM 4 (e.g., from ASTM 50 to ASTM 4, from ASTM 18 to ASTM 4, from ASTM 10 to ASTM 4, and the like).

Particle size distribution upper and lower ranges can be identified with “+” and “−” symbols, where a “+” before a sieve mesh number indicates that at least 90% the particles are retained by a sieve with the designated ASTM sieve mesh size, and a “−” before a sieve mesh number indicates that at least 90% of the particles pass through a sieve with the designated ASTM sieve mesh size. For example, edible particles ranging from ASTM 50 to ASTM 4 can be described as having a sieve distribution of ASTM −4/+50.

A given particle size distribution designation typically indicates that 90% or more of the particles will have sieve sizes between the two values. For example, 90% or more of the particles of edible particles having a sieve distribution of ASTM −4/+50 will be retained by a sieve having an ASTM mesh size of 50 and will pass through a sieve having an ASTM mesh size of 4. However, in some embodiments, a particle size distribution designation can specify that greater than 90% (e.g., 95% or 98%) of the particles of edible particles will have sieve sizes between the two values. For example, in some embodiments, edible particles can have a sieve distribution of ASTM −4/+18, where 95% of particles have sieve sizes between ASTM 18 and ASTM 4.

In some embodiments, particle size distribution can be further described as including a proportion of edible particles having a minimum sieve size. For example, edible particles having a sieve distribution of ASTM −4/+80 can have at least 20% (e.g., 30% or 35%) of the particles sized ASTM 50 or larger (e.g., at least ASTM 40).

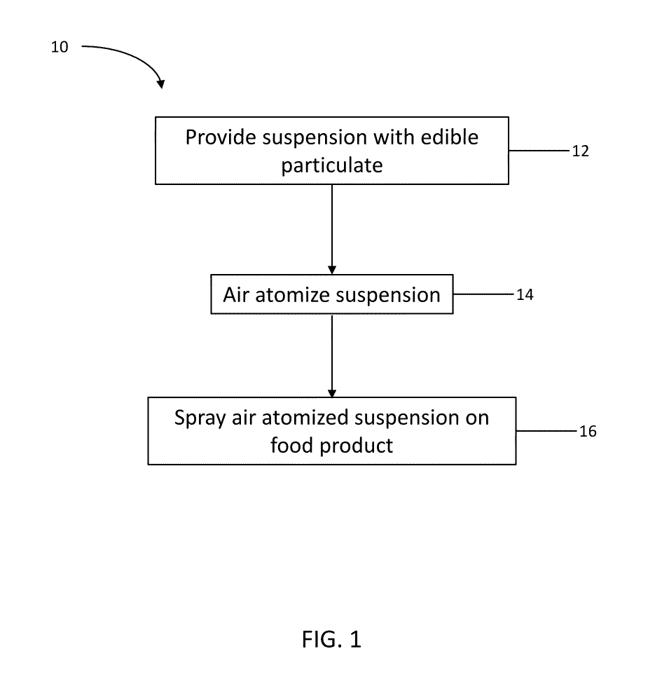

Referring to FIG. 1, a method for applying edible particles to a food product 10 includes a step 12 of providing a suspension including a liquid and edible particles. A suspension suitable for use in a method provided herein includes edible particles in an amount of from about 10% to about 60% by volume of the suspension. The amount of particles by volume of a suspension can be adjusted to provide a desired texture of a coated food product or to facilitate application to a food product. For example, in some embodiments, a suspension that includes larger edible particles (e.g., having a sieve distribution of ASTM −4/+18 or particles within a smaller range between ASTM 18 and ASTM 4) can include the edible particles in an amount of from about 10% to about 40% or about 12% to about 35% by volume of the suspension. In some embodiments, a suspension that includes smaller particles (e.g., having a sieve distribution of ASTM −18/+80 or particles within a smaller range between ASTM 80 and ASTM 18) can include the edible particles in an amount of from about 10% to about 60% or about 10% to about 40% by volume of the suspension.

Alternatively, edible particle size can be described using a measurement of the largest dimension of a particle. The largest dimension of a particle, as described herein, is the longest straight line distance from the surface of one side of the particle to another side of the particle. For example, for a spherically shaped particle, a measurement of the diameter of the particle can be used to describe the particle size. In another example, the largest dimension of an irregularly shaped particle can be empirically determined and measured. Edible particles useful for use in a method provided herein can include particles having a size of from about 0.18 mm to about 4.75 mm (e.g., from about 0.30 mm to about 4.75 mm or from about 1 mm to about 4.75 mm).

In some embodiments, within a plurality of particles, a percentage of particles can be identified as having a minimum size. For example, a plurality of particles can have a size range of from about 0.18 mm to about 1 mm, with at least 20% (e.g., 30% or 40%) of the particles having a size of at least 0.30 mm.

In some embodiments, a suspension suitable for use in a method provided herein includes edible particles in an amount of from about 5% to about 25% of the suspension by weight. The amount of particles per weight of a suspension can vary depending on the density of the edible particles and/or the density of a liquid component of the suspension. For example, edible particles with a higher density can make up a higher percentage of a suspension by weight than a suspension with particles with a lower density.

A liquid suitable for use in a suspension provided herein includes an edible liquid that can adhere the particles in the suspension to a food product. A liquid can function in any suitable manner in order to adhere edible particles to a food product. In some embodiments, a liquid can be tacky once applied to a food product in order to facilitate adhesion of edible particles to the food product. In some embodiments, a liquid can harden (e.g., by cooling, drying, or the addition of a setting component such as dextrose) once applied to a food product in order to facilitate adhesion of edible particles to the food product. Suitable liquids include, without limitation, liquids containing fat, a carbohydrate (e.g., a sugar, a starch, maltodextrin, and the like), a nut ingredient (e.g., a nut butter), a protein ingredient, a yogurt ingredient, or combinations thereof, and the like. A liquid suitable for use in a method provided herein includes true liquids, but can also include liquids containing small particles, such as a nut butter, that can act as a liquid to suspend edible particles described herein.

In some embodiments, a liquid suitable for use in a suspension provided herein can have a viscosity of from about 0.001 Pa·s to about 50 Pa·s at 40° C. as measured using a AR-G2 rheometer (TA Instruments, New Castle, Del., USA) with a 40 mm parallel plate geometry, where the shear rate is ramped from 300 to 1/sec and measurement taken at a shear rate of 1/sec. Viscosity of a liquid suitable for use in a suspension provided herein can be adjusted as appropriate to facilitate or maintain suspension of edible particles, to facilitate adhesion of the particles to a food product, and/or to provide for compatibility with equipment (e.g., pumps, piping, and the like) used in a method provided herein. For example, in some embodiments, a liquid suitable for use in a suspension that includes larger particles (e.g., having a sieve distribution of ASTM −4/+18 or particles within a smaller range between ASTM 18 and ASTM 4) can have a viscosity range that is higher (e.g., from about 10 Pa·s to about 30 Pa·s at 40° C.) than a liquid suitable for use in a suspension with smaller particles (e.g., having a sieve distribution of ASTM −18/+80 or particles within a smaller range between ASTM 80 and ASTM 18). However, it is to be understood that a liquid with a different viscosity may also be used as long as it is edible and can function to adhere edible particles to a food product.

A suspension provided in step 12 can be produced by combining a liquid and edible particles in any suitable manner and using any suitable equipment. For example, a suspension can be created by combining and mixing or otherwise agitating a liquid and edible particles. In some embodiments, a suspension can be mixed or agitated continuously or semi-continuously in order to prevent precipitation of the edible particles from the suspension.

A method of applying edible particles to a food product 10 includes a step 14 of combining a suspension provided herein with air in a nozzle assembly to produce an air atomized suspension.

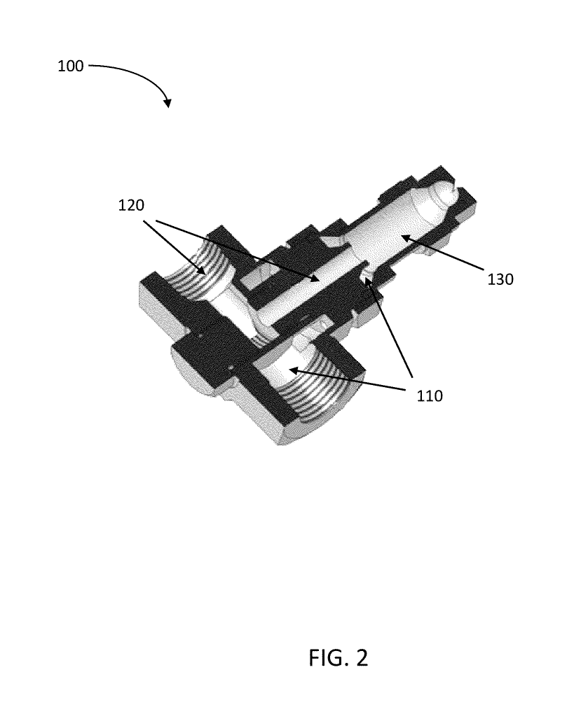

Referring to FIG. 2, a nozzle assembly 100 is configured to atomize a suspension provided herein can have an air passage 110, a suspension passage 120, and a mixing chamber 130. Generally, the opening size of a suspension passage 120 is sized to provide a maximum free passage (MFP) suitable for use with a suspension provided herein. As used herein, maximum free passage (MFP) refers to the maximum diameter of a particle that can pass through a passage without clogging. In some embodiments, a suspension passage 120 can provide a maximum free passage of from about 0.1 to about 0.5 inches (e.g., from about 0.1 to about 0.4 inches). It is to be understood that a suspension passage need not be round to provide a desired MFP, and can be sized appropriately to provide the desired MFP. Similarly, it is to be understood that a suspension passage can vary in size along its length as long as the desired MFP is maintained.

The opening size of suspension passage 120 can also be adjusted to allow for delivery of a suspension at a desired rate and/or pressure. For example, suspension passage 120 can be configured to deliver a suspension provided herein through nozzle assembly 100 at a pressure of from about 10 pounds per square inch to about 80 pounds per square inch (e.g., about 20 pounds per square inch to about 40 pounds per square inch). In some embodiments, a suspension passage 120 can be configured to deliver a suspension provided herein through nozzle assembly at a rate of about 8 pounds per minute to about 30 pounds per minute (e.g., about 10 pounds per minute to about 27 pounds per minute). Generally, a suspension passage with a larger opening can deliver a suspension at a higher rate, while a suspension passage with a smaller opening can deliver a suspension at a higher pressure. It is to be understood, however, that suspension delivery rate and/or pressure can be affected by other factors, such as capacity and/or speed of a pump used to deliver the suspension to a suspension passage.

Air passage 110 can be configured to deliver air at a pressure of from about 10 psi to about 80 psi (e.g., from about 15 psi to about 40 psi or about 20 psi to about 30 psi) through nozzle assembly 100. Generally, an air passage with a larger opening can deliver air at a higher rate, while an air passage with a smaller opening can deliver air at a higher pressure. It is to be understood, however, that air delivery rate and/or pressure can be affected by other factors, such as rate and/or speed of a pump used to deliver air to an air passage.

Mixing chamber 130 can be configured to receive a suspension from suspension passage 120 and air from air passage 110 and mix them prior to exiting nozzle assembly 100 in order to facilitate the formation of an air atomized suspension.

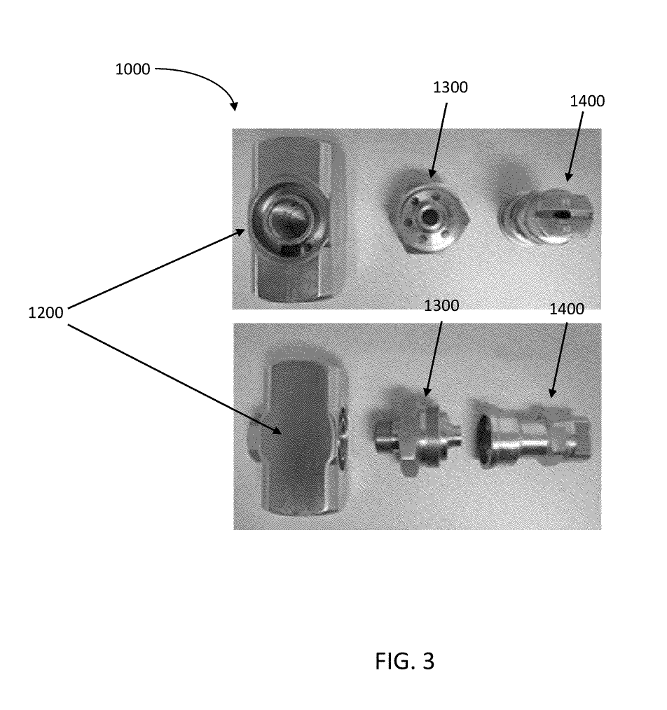

In some embodiments, a nozzle assembly 100 can be a unitary body, as shown in FIG. 2. In some embodiments, as shown in FIG. 3, a nozzle assembly 1000 can include multiple components, such as a nozzle body 1200, a fluid cap 1300 and an air cap 1400, that can be assembled together to function to air atomize a suspension provided herein.

A nozzle assembly can be configured to expel an air atomized suspension in any desired shape (e.g., fan-shaped, cone-shaped, and the like). A nozzle assembly that includes multiple parts can have an advantage of being more customizable than a nozzle assembly with a unitary body. For example, different air caps can be used to produce different spray patterns from a nozzle assembly as an air-atomized suspension exits the nozzle assembly.

In some embodiments, air can be combined with a suspension within a nozzle assembly (e.g., using an internal mix spray nozzle assembly). In some embodiments, an internal mix spray nozzle assembly can be used for suspensions with a relatively high viscosity.

In some embodiments, air is combined with a suspension after it has exited the nozzle assembly (e.g., using an external mix spray nozzle assembly). In some embodiments, an external mix spray nozzle assembly can be used for suspensions with relatively large particles.

A method of applying edible particles to a food product 10 includes a step 16 of spraying an air atomized suspension onto a food product. An air atomized suspension can be applied to any appropriate food product, such as ready to eat (RTE) cereal, candy or snack bars, nuts, dried fruits, candy pieces, seeds, cakes, puffed popcorn, or the like, using additional equipment, as appropriate. For example, an air atomized suspension can be applied to a food product (e.g., RTE cereal, nuts, puffed popcorn, and the like) while being tumbled in a rotary enrober. In another example, an air atomized suspension can be applied to a food product (e.g., candy bars, snack bars, and the like) on a conveyor.

Additional equipment can be used in method of applying edible particles to a food product provided herein, as appropriate. For example, a mixing vat can be used to combine edible particles with a liquid component to produce a suspension and a pump can be used to pump the suspension to a nozzle assembly. In some embodiments, equipment useful for performing a method provided herein (e.g., nozzle assembly, pump, enrober, and the like), can be combined with equipment (e.g., extruders, dryers, conveyers, and the like) used to manufacture a food product to be coated using a method provided herein. Thus, in some embodiments, a method provided herein can be performed in combination with the production of a food product to be coated.

The following examples describe methods of coating RTE cereals using a method provided herein. However, it is to be that the methods and ingredients can be adjusted for coating other food piece types. Thus, it is to be understood that the examples are not meant to be limiting to the scope of the invention described.

### EXAMPLES

### Example 1

A compound coating was prepared and mixed with cookie crumbs to produce a first suspension including cookie crumbs at about 14.3% by weight of the suspension and a second suspension including cookie crumbs at about 13.8% by weight of the suspension. Cookie crumb size distribution was ASTM −40/+80, with about 55% of the crumbs being ASTM 80 and about 45% being ASTM 40. The suspensions were used to test three nozzle assemblies shown in Table 1.

The suspensions were heated to 90° F. and pumped to the nozzle assembly to be tested where it was combined with air to form an atomized suspension. The each nozzle assembly and parameters tested are shown in Table 1.

TABLE 1

| | | | Sus- | Cookie | |
|---|---|---|---|---|---|
| | | Air | pension | crumb (% | |
| | | Pressure | Flow Rate | by wt | Suspension |
| Air cap | Fluid cap | (PSI) | (lbs/min) | suspension) | temp. (° F.) |
| 6550 | 0.408″ | 30-50 | 15-16 | 14.3 | 90 |
| VeeJet ® | diameter | | | | |
| | opening | | | | |
| 9540 | 0.408″ | 30-50 | 15-16 | 14.3 and | 90 |
| VeeJet ® | diameter | | | 13.8 | |
| | opening | | | | |
| 9560 | 0.408″ | 30 | 15-16 | 14.3 and | 90 |
| VeeJet ® | diameter | | | 13.8 | |
| | opening | | | | |

### Example 2

A slurry of 92% roasted peanut butter and 8% canola oil was prepared and mixed with granular peanuts to produce a suspension. Granular peanut size distribution was ASTM −4/+8, with about 39% of the peanut pieces being ASTM 4, about 52% being ASTM 6, and about 9% being ASTM 8.

The suspension was pumped to a nozzle assembly including a fluid cap with a 0.408″ diameter opening and 140 Flood-Jet nozzle where it was combined with air to form an atomized suspension. An initial run using about 6% by weight of granular peanuts was tested. A subsequent run with increasing levels of granular peanuts was tested as shown in Table 2. The suspension in the second run was recirculated through the system for a total of 4.5 hours, with additional granular peanuts added at about 2 hours post start up, about 3 hours post start up, about 3.5 hours post start up, and about 4 hours post start up. Table 2 shows system parameters at each time point.

TABLE 2

| | | | Sus- | | |
|---|---|---|---|---|---|
| | Granular peanuts | Air | pension | Pressure | |
| Time | (% by weight of | pressure | flow rate | at pump | Suspension |
| (min.) | suspension) | (PSI) | (lbs/min.) | (PSI) | temp. (° F.) |
| 0 | 7.8 | 20 | 19.65 | 40 | 120 |
| 35 | 7.8 | 20 | 19.65 | 45 | 115 |
| 61 | 7.8 | 20 | 19.2 | 58 | 110 |
| 107 | 7.8 | 20 | 19.76 | 60 | 110 |
| 132 | 7.8 | 20 | 19.6 | 60 | 108 |
| 173 | 10.5 | 21 | 19.4 | 62 | 106 |
| 190 | 13.1 | 20 | 19.6 | 70 | 104 |
| 210 | 13.1 | 20 | 19.6 | 65 | 105 |
| 228 | 13.1 | 20 | 19.8 | 61 | 110 |
| 245 | 17.8 | 20 | 19.8 | 65 | 112 |

The system was sprayed a suspension containing from about 8% to about 18% by weight granulated peanuts in a spray pattern suitable for food product coating without clogging.

It is to be understood that the described invention is not to be limited to the disclosed embodiments, but on the contrary, is intended to cover various modifications and equivalent arrangements included within the spirit and scope of the appended claims.

1. A method for applying edible particles to a food product, the method comprising:
a. providing a suspension including a liquid and the edible particles in an amount of from about 10% to about 60% by volume of the suspension, the edible particles having a sieve distribution of ASTM −4/+80 with at least 20% of the particles being ASTM 50 or larger;
b. combining the suspension with air in a nozzle assembly to produce an air atomized suspension; and
c. directing the air atomized suspension onto the food product to apply the edible particles to the food product.

2. The method of claim 1, wherein the edible particles have a sieve distribution of ASTM −4/+50.

3. The method of claim 1, wherein the edible particles have a sieve distribution of ASTM −4/+18.

4. The method of claim 1, wherein the edible particles have a sieve distribution of ASTM −4/+10.

5. The method of claim 1, wherein the air is delivered to the nozzle assembly at a pressure of from about 10 pounds per square inch to about 80 pounds per square inch.

6. The method of claim 1, wherein the nozzle assembly has a maximum free passage of from about 0.100 to about 0.400 inches.

7. The method of claim 1, wherein the edible particles comprise about 10% to about 40% by volume of the suspension.

8. The method of claim 7, wherein the edible particles comprise about 20% to about 25% by volume of the suspension.

9. The method of claim 1, wherein the edible particles comprise about 5% to about 25% of the suspension by weight.

10. The method of claim 1, wherein the air atomized suspension is expelled from the nozzle assembly in a cone-shaped or fan-shaped spray.

11. The method of claim 1, wherein the edible particles comprise nut pieces.

12. The method of claim 11, wherein the liquid comprises a nut ingredient.

13. The method of claim 1, wherein the edible particles comprise cracker, cookie, or ready-to-eat cereal crumbs.

14. The method of claim 13, wherein the liquid comprises a fat ingredient.

15. The method of claim 13, wherein the liquid comprises a carbohydrate ingredient.

16. The method of claim 1, wherein the liquid comprises a protein ingredient.

17. The method of claim 1, wherein the liquid has a viscosity at 40° C. of from about 0.001 Pa·s to about 50 Pa·s.

18. A method for applying edible particles to a food product, the method comprising:
a. providing a suspension including a liquid and the edible particles in an amount of from about 10% to about 60% by volume of the suspension, the edible particles having a size of from about 0.18 mm to about 4.75 mm with at least 20% of the particles being 0.30 mm or larger;
b. combining the suspension with air in a nozzle assembly to produce an air atomized suspension; and
c. directing the air atomized suspension onto the food product to apply the edible particles to the food product.
